(19) United States
(12) Patent Application Publication
(10) Pub. No.: US 2011/0238608 A1
(43) Pub. Date: Sep. 29, 2011

(54) METHOD AND APPARATUS FOR PROVIDING PERSONALIZED INFORMATION RESOURCE RECOMMENDATION BASED ON GROUP BEHAVIORS

(75) Inventor: Sailesh Kumar Sathish, Tampere (FI)

(73) Assignee: Nokia Corporation, Espoo (FI)

(21) Appl. No.: 12/731,785

(22) Filed: Mar. 25, 2010

(51) Int. Cl. G06N 5/02

(52) U.S. Cl. 706/47

(57) ABSTRACT

An approach is provided for suggesting information resources based on context, preferences, and group behavior of a community, culture, country, or combination thereof that the user belongs to. A recommendation application applies one or more rules to select a weight value for tokens within a language topology based upon group behaviors of a community, culture, country, or combination thereof that a user belongs to. The recommendation application adjusts semantic structures of a plurality of information resources based upon the weighted topology. The recommendation application suggests one or more of the information resources to the user based, at least in part, on the adjusted semantic structures.

### BACKGROUND

Service providers (e.g., wireless, cellular, Internet, content, social network, etc.) and device manufacturers are continually challenged to deliver value and convenience to consumers by, for example, providing compelling network services and advancing the underlying technologies. Increasingly, these network services provide easy access to a vast library of online and offline information resources (e.g., web pages, blogs, discussion forums, reviews and ratings, online databases, local databases, services, applications, etc.). The existing search engines and recommendation engines generally either recommend generic choices or recommend based on user context or preferences without accounting for social behavior differences in different communities, cultures, countries, etc. In many cases, users are easily overwhelmed by the volume and scope of available information, particularly when the users are using a mobile terminal (e.g., mobile handset, smartphone, etc.) where data entry, display area, processing power, data storage, and the like are relatively limited. Accordingly, service providers and device manufactures face significant technical challenges in recommending individual users of information resources that are interesting and relevant to each individual user.

### SOME EXAMPLE EMBODIMENTS

Therefore, there is a need for an approach for providing personalized information resource recommendation based on group behaviors.

According to one embodiment, a method comprises applying one or more rules to select a weight value for tokens within a language topology based upon group behaviors of a community, culture, country, or combination thereof that a user belongs to. The method also comprises adjusting semantic structures of a plurality of information resources based upon the weighted topology. The method further comprises suggesting one or more of the information resources to the user based, at least in part, on the adjusted semantic structures.

According to another embodiment, an apparatus comprising at least one processor, and at least one memory including computer program code, the at least one memory and the computer program code configured to, with the at least one processor, cause, at least in part, the apparatus to apply one or more rules to select a weight value for tokens within a language topology based upon group behaviors of a community, culture, country, or combination thereof that a user belongs to. The apparatus is also caused to adjust semantic structures of a plurality of information resources based upon the weighted topology. The apparatus is further caused to suggest one or more of the information resources to the user based, at least in part, on the adjusted semantic structures.

According to another embodiment, a computer-readable storage medium carrying one or more sequences of one or more instructions which, when executed by one or more processors, cause, at least in part, an apparatus to apply one or more rules to select a weight value for tokens within a language topology based upon group behaviors of a community, culture, country, or combination thereof that a user belongs to. The apparatus is also caused to adjust semantic structures of a plurality of information resources based upon the weighted topology. The apparatus is further caused to suggest one or more of the information resources to the user based, at least in part, on the adjusted semantic structures.

According to another embodiment, an apparatus comprises means for applying one or more rules to select a weight value for tokens within a language topology based upon group behaviors of a community, culture, country, or combination thereof that a user belongs to. The apparatus also comprises means for adjusting semantic structures of a plurality of information resources based upon the weighted topology. The apparatus further comprises means for suggesting one or more of the information resources to the user based, at least in part, on the adjusted semantic structures.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing personalized information resource recommendation based on group behaviors, according to one embodiment;

FIG. 2 is a conceptual diagram of the system of FIG. 1, according to one embodiment;

FIG. 3 is a diagram of the components of a recommendation application, according to one embodiment;

FIG. 4 is a flowchart of a process for providing personalized information resource recommendation based on group behaviors, according to one embodiment;

FIG. 5 illustrates a graphical representation of a group behavior structure comprising a plurality of language tokens, according to one embodiment;

FIG. 6 is a diagram showing major fishing communities around the world, according to one embodiment;

FIG. 7 shows an example of weight values among group behavior tokens in a fishing community, according to one embodiment;

FIG. 8 is a flowchart of a process for adjusting the semantic structures of information resources based on a topology, according to one embodiment;

FIG. 9 is a diagram of the components of a recommendation engine, according to one embodiment;

FIG. 10 is diagram of a user interface presenting information resources, according to one embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for providing personalized information resource recommendation based on group behaviors are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “information resources” refers to any entity or object that is addressable or otherwise identifiable in an information system (e.g., the Internet, a private network, local device storage, network storage, etc.). By way of example, information resources may include web pages, documents, audio, video, multimedia files, images, services, applications, films, television, books, news, images, etc. In one embodiment, information resources are identified using a Uniform Resource Identifier (URI) that can encompass both a Uniform Resource Locator (URL) and/or a Uniform Resource Name (URL). It is also contemplated an information resource may be identified using any network naming or identification system.

As used herein, the term “community” refers to a residential community in a geographic area (e.g., a neighborhood, town, city, etc.) that is composed mostly of residents. A community may include a group of people having ethnic or cultural or religious characteristics in common and occupying the same geographical area. In certain embodiments, it is also contemplated that community may refer to any group of people in general.

As used herein, the term “culture” refers to a particular group of people sharing attitudes, behaviors, knowledge, values, and other characteristic at a particular time and geographic area.

As used herein, the term “country” refers to the people who live in a nation or country that is a particular geographical region of definite boundary (usually serving some special purpose or distinguished by its people or culture or geography). Usually, but not always, a country coincides with a sovereign territory and is associated with a state, nation or government.

As used herein, the term “preference structure” refers to mapping of discrete preference data of a user, such as user entries and/or online interactions to record and reflect user preferences or dislikes that include categories such as food, clothing, housing, vehicles, learning, entertainments, etc. In an effort to organize the user preference data, the preference structure is inserted with instances and events that contain possible relationships that are discoverable via, for instance, data-mining or other querying processes. By way of example, the preference structure allows examining and data-mining for characteristics and features of an individual user's preference data and/or preference data associated with a group of users. Knowledge of individual and/or group preferences can be accumulated by assimilating features of the distal and proximal preferences.

As used herein, the term “context structure” refers to mapping of discrete context characteristics/data of a user and/or the user terminal, such as time, location, current activity, weather, etc. associated with the user. In an effort to organize the user context data, the contextual structure is inserted with instances and events that contain possible relationships that are discoverable via, for instance, data-mining or other querying processes. By way of example, the contextual structure allows examining and data-mining for characteristics and features of an individual user's context data and/or context data associated with a group of users. Knowledge of individual and/or group context can be accumulated by assimilating features of the distal and proximal contexts. In another embodiment, the preference structure is merged into the context structure, and the new structure is also referred as a context structure.

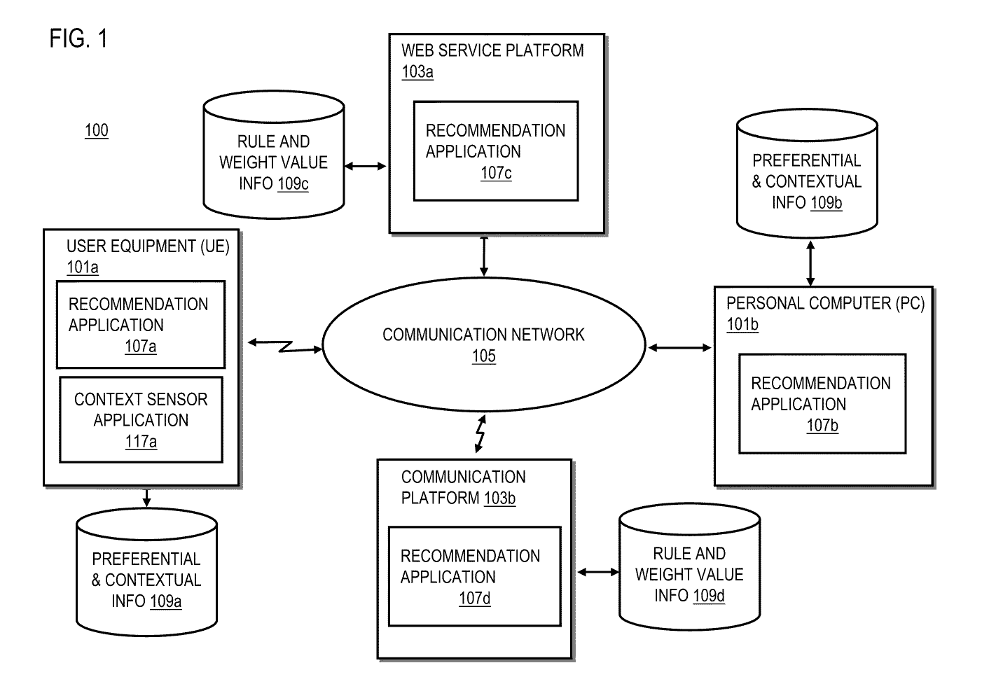

FIG. 1 is a diagram of a system capable of providing personalized information resource recommendation based on group behaviors, according to one embodiment. It is noted that the existing web search engines traditionally are designed to search for information on the Internet, and to present the search results in a list of web pages, images, videos, and other types of files. Some search engines survey or mine user entries and data available in public and/or private databases to collect user preferential data (e.g., categories of points of interests, etc.). However, the search engines often require the user's active participation, and the results of these traditional searches are highly dependent on the skill and familiarity a user has with a particular search engine. As to recommendation engines, they typically compare a user's profile to some reference characteristics, and predict a potential “rating” that a user would give to an information resource. For example, these characteristics may be extracted from the information resource via the content-based approach or from a group of like users (i.e., the collaborative filtering approach). Most recommendation engines are information-resource-type specific, such as recommending movies, music, or books. Some recommendation engines are website-specific such that they only track users' online behaviors site wide, and provide to the users offers available via a particular website. There is a need for a recommendation engine for pushing a list of contextually and preferentially personalized information resources (e.g., URLs) list to a user device interface. The list of URLs is dynamic and reflects services that are available within the user vicinity or matches user personal, social, and geographic context. Currently, there is no recommendation engine providing personalized information resource recommendations accounting for group behavior differences of communities, cultures, countries, etc., when apply the same backend data to all users around the globe.

To address these problems, the system 100 introduces a framework for rule-based group behavior modeling to support an information resource recommendation service. The framework takes into account importance of certain class of data at specific use context and situations. Moreover, the framework accounts for community, cultural and country specific differences, while the information resource recommendation service is destined to have a world wide roll out. The system 100 generates data weightage in a dynamic manner by modeling different aspects of group behaviors through rule sets while maintaining a recommendation platform generic. In one embodiment, the list of URLs is 24/7 updated and available for the user to view, without the user taking any action. Optionally, the system 100 applies a user profile (including user preferences and dislikes such as food, clothing, housing, vehicles, learning, entertainment, etc.) to enhance the information resource recommendations.

The system 100 includes a universal topology comprising language tokens of all languages. In this context, a “token” is a single data point or variable within the universal topology of common data points. The universal topology is basically a dictionary or language model. The language model may be represented in any information representation format or structure, such as a resource description framework (RDF) graph. RDF graphs represent decision diagrams and describe resources with classes, properties, and values. A node/token/resource is any object which can be pointed to by a uniform resource identifier (URI), properties are attributes of the node, and values can be either atomic values for the attribute, or other nodes. RDF Schema provides a framework to describe application-specific classes and properties. Classes in RDF Schema are like classes in object oriented programming languages. This allows tokens to be defined as instances of classes, and subclasses of classes.

The system 100 may construct a context structure at a web service platform or receive from a user terminal the context structure. The context structure includes one or more of the language tokens that reflect current context and preferences of a user. In one embodiment, the system 100 sets weight values for tokens within the universal/language topology considering group behaviors. In another embodiment, the system 100 extracts only a part of the topology that corresponding to the context structure, and then sets weight values only for tokens within the context structure considering group behaviors.

The system 100 develops rules for applying token values to the topology based upon user group studies and behavior studies. In one embodiment, the rules can be statistically defined, or dynamically constructed at the time when pushing out the list of URLs. The system 100 then decides which rules are applicable to a particular community, culture, or country the user belongs to at the time of pushing out the list of URLs. The system 100 applies each of the applicable rules to select a weight value for each of the tokens in the topology or in the context structure, and then aggregates the weight values of all applicable rules for each token as a weightage of the token. The weightage of token is determined by a corresponding context token, the contact token value, and the weight values associated with the token by different applicable rules. The system 101 thus obtains a weighted context structure or a weighted topology of the particular community, culture, or country. The system then parses the weightages and the associated tokens from the weighted context structure or topology. The weightages of the topology change over time depending on the dynamics of the community as well as how the community/rules are modeled. By way of example, a recently finished daycare center near the town center attracts a lot of young families to switch from the old daycare service within the community center to the new daycare center. The traffic pattern near the town center as well as the shopping routes of the parents are changed by the presence of the new day-care center. Therefore, the rules and the weightages of the topology are changed accordingly.

The system 100 further constructs a semantic structure including one or more of the language tokens for each of a plurality of information resources. The system 100 matches the semantic structure of each information resource against the context structure or topology. For each of the semantic structures matching matrix with a matrix of the context structure or topology, the system 100 increases each token value in the matrix of the semantic structures by a corresponding weightage in the matrix of the context structure or topology. The system 100 collects a predetermined number of the information resources with an aggregate matrix value higher than other information resources, and recommends them to the user in a list.

The invention reuses the same topology, the rules, and almost all of the backend processing for worldwide rollout while reflecting behavioral patterns of any particular community, culture, or country. The recommendations are based on user preference, context, and group behavior patterns while using the same backend data. The backend retains the generic nature of a recommendation engine while bringing in one additional module that models community/culture/county behaviors in a scalar manner. This flexibility is reflected in three internal modules of weighted topology: the topology itself, the rule sets and the weight values. The system 100 thus can be adapted to model almost all group behaviors of different communities, cultures, and countries.

To provide contextually relevant assistance while under the constraints of data storage and computing power, the system 100 further simplifies representation of the list of recommended information resources as an icon, button, or the like to be selected by the user, thus triggering the presentation of the list on demand. In addition, the system 100 displays/maintains only the most prominent information resources. For example, if the user moves to a new community or travels to a new city, the system 100 extracts a generalized contextual structure for that particular community or city.

The system 100 further supports user classification or categorization of contextual data by tagging locations the user visit, such that the user can explicitly express the user's preferences. In addition, given that users are implicitly expressing their preferences in browsing the information resources, the system 100 tags user's interactions with locations within the list of information resources as the user's implicit preferences. The system 100 further enhances the recommendations based upon the user's tagging and browsing activities.

As shown in FIG. 1, the system 100 comprises a user equipment (UE) 101a connected to a personal computer 101b, a web service platform 103a, and a communication platform 103b via a communication network 105. Each of the UE 101a, the personal computer 101b, the web service platform 103a and the communication platform 103b has a recommendation application 107 and a database 109 for storing information. In particular, UE 101a and the personal computer 101b respectively have databases 109a and 109b for storing preferential and contextual information. The web service platform 103a and the communication platform 103b respectively have databases 109c and 109d for storing rule and weight value information.

The user equipment (UE) 101 exchanges context and preference information with a recommendation application 107c via the communication network 105. For the sake of simplicity, FIG. 1 depicts only a single UE 101 and a personal computer 101b in the system 100. However, it is contemplated that the system 100 may support any number of user terminals up to the maximum capacity of the communication network 105. For example, the network capacity may be determined based on available bandwidth, available connection points, and/or the like. As described previously with respect to the system 100, the recommendation application 107c uses the user context and preference information to automatically generate recommendations of potentially relevant information resources (e.g., URLs) to present at the UE 101. In the example of FIG. 1, the recommendation application 107c stores context, preference, and/or resource information in the database 109c. By way of example, the resource information includes one or more identifiers, metadata, access addresses (e.g., network addresses such as a URI, URL, URN, or Internet Protocol address; or a local address such as a file or storage location in a memory of the UE 101), description, categories, preference information, or the like associated with the information resources. In one embodiment, one or more of the information resources may be provided by the web service platform 103a which includes one or more information resources (e.g., web pages, documents, files, media, etc.) and/or by the communication platform 103b which includes services (e.g., music service, mapping service, video service, social networking service, content broadcasting service, etc.).

In certain embodiments, the recommendation application 107c of the web service platform 103a interacts with the recommendation application 107a of the UE 101a to automatically display information resource recommendations. The recommendation application 107a displays, for instance, a user interface that shows a list of information resources and/or links to the information resources (e.g., identified by corresponding Uris) that changes as the context of the user and/or the UE 101 changes. In one use case, the user needs only to check the user interface for the list and selects (by clicking, touching, etc.) on the appropriate one of the information resource to access the resource and, if necessary, invoke a corresponding application or service. For example, if the information resource is a web page, selecting the resource invokes a browser application (not shown) on the UE 101 to display the web page. In one embodiment, the recommendation application 107a may operate on a common Web Run Time (WRT) platform as a client application of the recommendation application 107c. In addition or alternatively, the recommendation application 107a can be implemented in another programming language or development tool including Java, Qt, and the like.

The UE 101 also includes a context sensor application 117a for detecting or sensing one or more contextual characteristics (e.g., time, location, current activity, etc.) associated with device. This contextual information can then be transmitted to the recommendation application 107a to construct a context structure for use by the recommendation application 107c in generating the suggested list of information resources. By way of example, the context sensor application 117a may include one or more global positioning system (GPS) receivers for determining a location, an accelerometer to determine a movement or tilt angle, a magnetometer to determine a directional heading, a microphone to determine ambient noise, a light sensor, a camera, and/or the like. In addition or alternatively, the recommendation application 107c may obtain contextual information from one or more of the web services (e.g., a weather service, a location tracking service, social network service, etc.).

By way of example, the UE 101 is any type of mobile terminal, fixed terminal, or portable terminal including mobile handsets, mobile phones, mobile communication devices, stations, units, devices, multimedia tablets, digital book readers, game devices, audio/video players, digital cameras/camcorders, positioning device, televisions, radio broadcasting receivers, Internet nodes, communicators, desktop computers, laptop computers, Personal Digital Assistants (Pads), or any combination thereof. Under this scenario, the UE 101 employs wireless links (e.g., cellular radio links) to access the communication network 105 and/or the recommendation application 107c. In addition or alternatively, it is contemplated that the UE 101 may also employ wired connections (e.g., wired Ethernet connections) to the network 105 and/or the recommendation application 107c. It is also contemplated that the UEs 101a, 101b can support any type of interface to the user (such as “wearable” circuitry, etc.).

Additionally, in certain embodiments, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

By way of example, the UE 101a, the personal computer 101b, the web service platform 103a and the communication platform 103b communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the recommendation application 107c of the web service platform 103a and the recommendation application 107a of the UE 101a may interact with each other according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

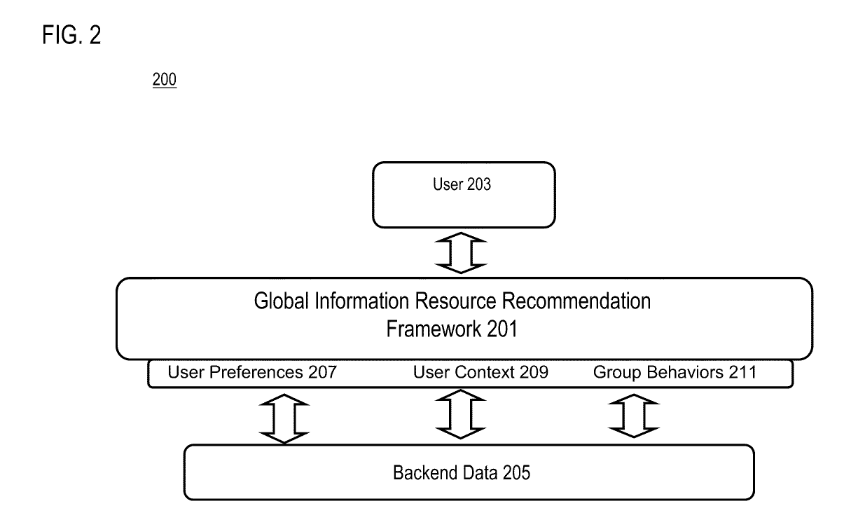

FIG. 2 is a conceptual diagram 200 of the system of FIG. 1, according to one embodiment. In one embodiment, the system 100 deploys a global information resource recommendation platform 201 that generates a personalized information resource list for each user 203 based upon the same backend data 205 by considering user preferences 207, user context 209, and group behaviors 211 of a community, couture, country that the user belongs to, etc.

The user 203 may be an individual, a business and legal entity, etc. The backend data 205 includes an original topology that are collected from existing worldwide online and offline information sources, such as online or offline surveys, public record (e.g., a birth certificate, school record, driver's license, tax record, real property record, criminal records, etc.), transaction (e.g., flight tickets, movie tickets, CD/DVD/book purchases, restaurant/store/hospital/gym visits, car/house/education loans, credit debts, phone/utility/heating bills, internet browsing behaviors, etc.), activity (e.g., basketball team, hike, concert, etc.), visit (e.g., a hospital, gum, park, restaurant, museum, etc.), interaction (e.g., blog, discussion forum, social network profile, online gaming, virtual life via an avatar, etc.), communication content item (e.g., email, SMS, MMS, call, media conference, etc.), membership (e.g., golf club, airline frequent flyer, speaker bureau, etc.), or a combination thereof.

The user preferences 207 include user information and a preference data structure that is multidimensional for each user. Typical user information elements include a user identifier (e.g., telephone number), user device model (e.g., to identify device capabilities), age, nationality, language preferences, interest areas, login credentials (to access the listed information resources of external links). In one embodiment, the preference data structure is automatically generated by the system 100 from the backend data 205 and/or external information sources. In another embodiment, the preference data structure is recorded at the UE 101a based upon user personal data, online interactions and related activities with respect to specific topics, points of interests, or locations, etc. It is contemplated that the user can define any number of preference elements and tokens to be included in the preference structure. In addition or alternatively, an inference engine can decide what parameters or attributes to choose to represent user interest or preferences. Then, the particular preference structure is chosen to represent preference tokens and assigned token values.

The user context 209 includes a multidimensional contextual data structure for each user at any given moment. In one embodiment, the contextual data structure is automatically generated by the system 100 from the backend data 205 and/or external information sources. In another embodiment, the contextual data structure is recorded at the UE 101a based upon user personal data, online interactions and related activities with respect to specific topics, points of interests, or locations, etc. at any given moment.

This contextual data elements may include location (where the user/UE is applicable, wherein the context information source is applicable. etc), active dates (the range of dates for which the user/UE and/or the context information source is available), sub-identifiers (each sub-identifier associated with a different location and/or applicable context information source), event type (event information associated with the user/UE), time (of the event if the user/UE involves), applicable context (in which the context information source is applicable), context source (what sensors, services, applications, etc. can provide the related contextual information), and optionally preference elements (associated with what preferences data elements), etc.

By way of example, the system 100 analyzes the contextual characteristics (e.g., time, location, current activity, historical activity, etc.) referenced in the context information sources to construct a context structure using, for instance, data mining techniques (e.g., word parsing followed by a probabilistic analysis of the parsed words to categorize the context information sources) that reflects the context the user. Tokens matching context-related terms are then included in the context structure of the user. Inclusion in the context structure means that a token describes a context condition (e.g., a time, place, location, activity, etc.), a context source (e.g., a service or sensor that provides that contextual characteristics to determine a particular context condition), and/or other context-related information associated with the user. The same data mining techniques can also be used to determine and analyze information associated with user preference characteristics (e.g., food, clothing, housing, vehicles, learning, entertainments, etc.) to construct the preference structure of the user.

The group behaviors 211 of a community, culture, country that the user belongs to include a multidimensional behavior structure of the particular community, culture, or country. In one embodiment, the behavior data structure is generated by the system 100 from external information sources and then trained/refined with the backend data 205. By way of example, the system 100 divides a target area into prototypical community types using a statistical cluster analysis to identify meaningful spatial aggregates as communities based upon some behavior influence elements. The system 100 then tests these elements' influences on behavior decisions of members within each community type with respect to different behavioral categories such as commuting, food shopping, exercising, etc. For example, behavior influence elements with respect to transit choices and commuting behaviors include location, population density, street design, transit access, highway access, etc. The behavior influence elements are used as tokens in a behavior structure for commuting to work.

It is noted that a considerable amount of relevant user activities actually happen when user is offline (i.e., not connected into Internet). Therefore, the system 100 introduces the capabilities to record and track the offline activities, such as the user's visits to the point of interest (e.g., a community center, office, supermarket, restaurant, etc.). The system 100 can track user's offline activities including (1) GPS data indicating the user's actual visits to the community center, (2) bills/receipts charged for the user's actual visits to the community center, etc., (3) mentioning the community center by the user in the user's calendar appointments, (4) calling by the user inside the community center, (5) voting by the user the community center or an establishment in the community center as important (e.g., in a survey), (6) real world media items (articles, music, video, photos, etc. posted in blogs on web pages, etc.) created by the user regarding the community center, etc. The system 100 can also look for the name of the community center mentioned in text or audio messages created by the user. In this case, the system 100 determines which community center is represented in articles, music, video, photos by looking via a GPS position and heading data in the data files. The system 100 may conduct content analysis of the communications (e.g., text or audio messages, etc.) of the user to look for expressions of personal importance towards the community center, such as “I really love the Crazy Horse Community Center, I visit it as often as I can”, “I take every opportunity to dine at the Crazy Horse Community Center,” etc. The system 100 may explore associations between the user and the community center by accessing databases storing data on where the user lives in, works in, has a membership to (e.g. a fitness center with tin the community center, etc.), as well as databases storing data on where (the community centers) the user's friends or contacts live in, work in, have a membership to, etc. Preferably, the system 100 collects all raw user activity and group behavior information.

The global information resource recommendation platform 201 adjusts the semantic structures of information resources based upon the group behavior structure, thereby suggesting a list of information resources to the user. The list is then displayed on the user's device and automatically updated as the contextual characteristics of the UE change. An advantage of this approach is that the user is always presented with an updated list of information resources that are contextually or preferentially relevant to the user without specific user intervention. In addition, personalized information resource recommendations are always available even when the user profile is not available or not updated. By way of example, the user profile may not be available because the user does not have much, if any, online activities (e.g., a new user in a developing country), or the user deliberately opts out data sharing under privacy laws and policies. In these cases, the system 100 provides information resource recommendations based upon a community model, then gradually refines the information resource recommendations based upon user behaviors as the user becomes involved in more online activities.

In one embodiment, the list provides a direct link (e.g., via a URL) to the information resource, and the user need only to select the link to immediately access the suggested information resource. Further, the system 100 may store login credentials and/or other access information related to the suggested information resource to facilitate quick access to the information resource. In this way, the user need not laboriously enter access information or search for information corresponding to resources.

In another embodiment, the global information resource recommendation platform 201 enables third parties (e.g., user communities, social networking groups, nonprofit organizations, businesses, advertisers, etc.) to specify or contribute to the predetermined set of information resources from which the system 100 will make suggestions. Enabling this function advantageously allows the user to leverage the favorite information resources, preferences, and/or context of other parties that may share similar interest, so that the user needs not to define the information resources. By way of example, these third parties may also include external bookmarking services (e.g., Digg®, Facebook®, etc.) that tag and categorize information resources (e.g., web pages) based on user preferences and/or context. When the third party is an advertiser, the advertiser may offer incentives for the system 100 or the user to consume advertisements by giving out discounts, coupons, free samples/gifts, etc.

The global information resource recommendation platform 201 can directly import the preference structure and the context structure of a user from the third parties, instead of the UE 101. In another embodiment, the global information resource recommendation platform 201 merges the preference structure and the context structure from the third parties with the preference structure and the context structure from the UE 101.

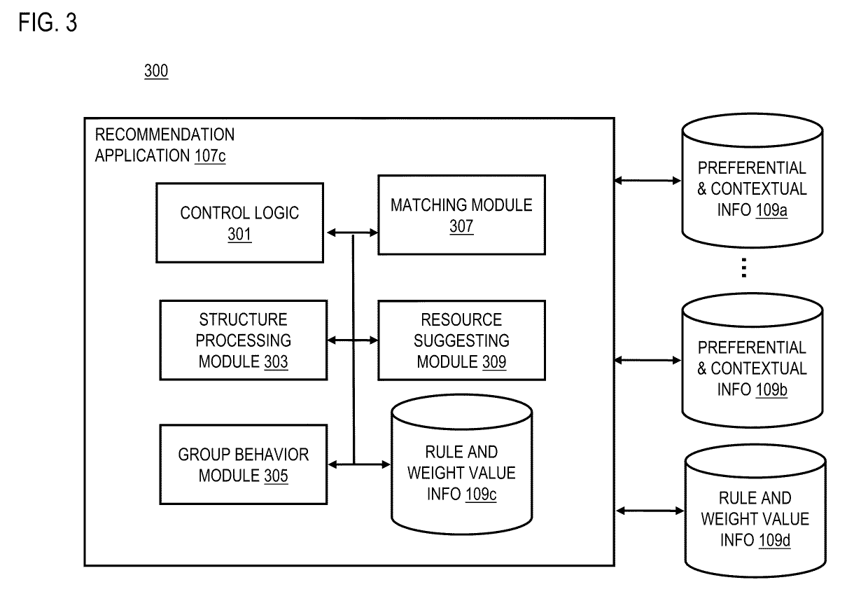

FIG. 3 is a diagram 300 of the components of a recommendation application, according to one embodiment. By way of example, the recommendation application 107c of the web service platform 103a includes one or more components for suggesting information resources based on contextual, preferential and group behavior information. It is contemplated that the functions of these components may be combined in one or more components or performed by other components of equivalent functionality. In this embodiment, the recommendation application 107c includes at least a control logic 301 which executes at least one algorithm for performing functions of the recommendation application 107c. For example, the control logic 301 interacts with a structure processing module 303 to process a context structure of the user, as well as semantic structures of the information resources.

In one embodiment, the structure processing module 303 triggers a user interface executing on, for instance, the UE 101 to monitor user inputs to determine a context structure of the user. In addition or alternatively, the structure processing module 303 provides a web-based interface or portal for retrieve information of each of information resources and generates s semantic structure for each information resource. In addition, the structure processing module 303 triggers the user interface to enable the user to specify personal preferences or other data (e.g., login credentials or other access credentials) associated with each information resource. It is contemplated that the information resources may be external sites, other programs (e.g., a web browser), or services (e.g., social networking services). Te structure processing module 303 then stores context and preference structures of the user, and the semantic structures of the information resources in, for instance, the database 109c.

In another embodiment, the structure processing module 303 supports a web service platform to monitor inputs of the user, a community or group of users, and/or other third parties (e.g., businesses, service providers, network operators, content providers, etc.) to determine a context structure of the user.

After storing context and preference structures and the semantic structures of the information resources, the control logic 301 interacts with a group behavior module 305 to incorporate group behaviors of a geographically defined group into recommendations to the user. By way of example, the group behavior module 305 applies one or more rules to select a weight value for each token within the universal topology or the context structure of a user based upon group behaviors of a community, culture, country, or combination thereof that the user belongs to. The context structure includes language tokens that reflect current context (e.g., time. location, event, etc.) of the user. The group behavior module 305 extracts the weight values and the corresponding tokens from the weighted topology.

The control logic 301 interacts with a matching module 307 to match semantic structures of the information resources against the topology, thereby adjusting semantic structures of a plurality of information resources based upon extracted weight values of the corresponding tokens. By way of example, for each of the semantic structures having a matrix matching with a matrix of the topology, the control logic 301 increases each token value in the matrix of the semantic structures by a corresponding weightage in the matrix of the topology. The control logic 301 also include a resource suggesting module 309 that suggests a list of information resources to the user based, at least in part, on the increased token values of the semantic structures.

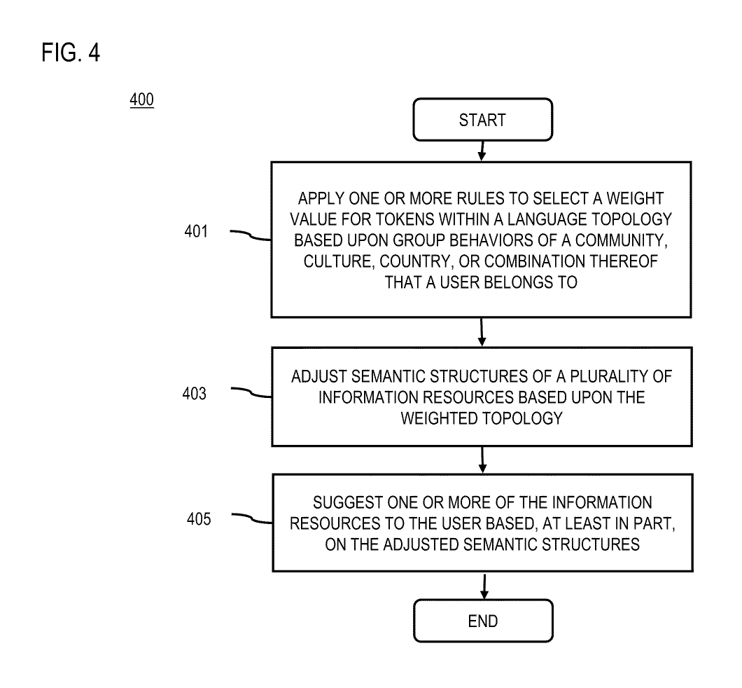

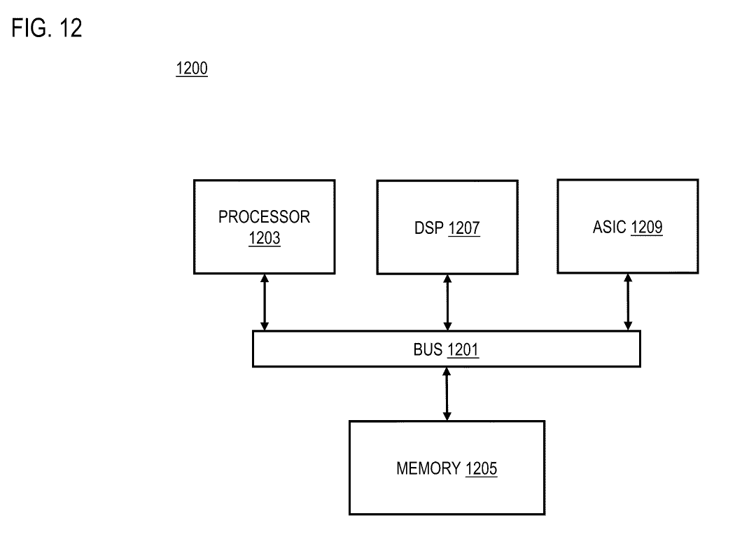

FIG. 4 is a flowchart of a process for providing personalized information resource recommendation based on group behaviors, according to one embodiment. In one embodiment, the recommendation application 107c of the web service platform 103a performs the process 400 of FIG. 4 and is implemented in, for instance, a chip set including a processor and a memory as shown in FIG. 12. In Step 401, the recommendation application 107c applies one or more rules to select a weight value for tokens within a language topology based upon group behaviors of a community, culture, country, or combination thereof that the user belongs to. The recommendation application 107c provides a framework for rule-based group behavior modeling to support an information resource recommendation service as follows. The tokens within the language topology may include all tokens in the topology or only tokens that constitute a context structure reflecting current context of the user. When the process is implemented based upon all tokens in the topology, the results will be more comprehensive. When the process is implemented based upon only tokens that constitute a current context structure, the process is accelerated.

The language tokens of the context structure are extracted from the universal topology, i.e., a dictionary including words of all languages. The language topology enables the recommendation applications to infer the context structure. The context structure may also include one or more language tokens that reflect user characteristics, interests, preferences, or a combination thereof.

The context structure may be received from the UE 101 or generated by the recommendation application 107c of the web service platform 103a. The context structure, for instance, represents language tokens included in the context of the user when the recommendation application 107c prepares to make recommendations.

For instance, the recommendation application 107a of the UE 101 uses asynchronous JavaScript to send an extensible markup language (XML) wrapped context structure to the recommendation application 107c. The ontology information will be encoded within the context structure and the recommendation application 107c can use one of many ways to obtain the data. One way is to use, for instance, a standards compliant World Wide Web Consortium (W3C) delivery context client interfaces (DCCI) extension to the Web Runtime (WRT) application environment that provides context data via context objects. In addition, the recommendation application 107c can use contextual access application programming interfaces (APIs) to directly retrieve contextual information or a context structure from the UE 101. The contextual information may include, for instance, a date, a time, a location, a current activity of the user, a history of activity, or a combination thereof.

The universal topology also enables the recommendation application 107c of the web service platform 103a to infer the semantic structures of information resources. In one embodiment, the recommendation application 107c from the rules for applying weights to tokens by based upon state languages on demand. In another embodiment, the rules are pre-defined for a plurality of sets of context.

By way of example, for each information resource, text or other information is extracted from the information sources in the predetermined set as language tokens (e.g., each language token represents a word or phrase) of the universal topology. For instance, each of the information resources is crawled and parsed to obtain text. Since the text data are largely unstructured and can comprise tens of thousands of words, automated topic modeling can be used for locating and extracting language tokens from the text. In one embodiment, the recommendation application 107c extracts the noun tokens, and then performs a histogram cut to extract only the least common nouns. To extract the noun tokens, the recommendation application 107c can deploy a part-of-speech tagging (POTS) to mark up nouns in the text. POTS is a process of marking up nouns in a text (corpus) as corresponding to a particular part of speech, based on both its definition, as well as its context. Part-of-speech tagging is more than just having a list of words and their parts of speech, because some words can represent more than one part of speech at different times. For example, “shops” is usually a plural noun, but can be a verb. The recommendation application 107c then extracts nouns using the universal topology, and stores the noun tokens. The noun tokens obtained is then used to build a semantic structure to represent the information resource by extracting tokens with similar probability or performing other similar probabilistic analysis of the tokens.

In one example, topic models, such as Latent Dirichlet Allocation (LDA), are useful tools for the statistical analysis of document collections. For example, LDA is generative probabilistic model as well as a “bag of words” model. In other words, the words or tokens extracted from text of the information resources are assumed to be exchangeable within them. The LDA model assumes that the words of each document arise from a mixture of topics, each of which is a probability distribution over the vocabulary. As a consequence, LDA represents documents as vectors of word counts in a very high dimensional space, while ignoring the order in which the words or tokens appear. While it is important to retain the exact sequence of words for reading comprehension, the linguistically simplistic exchangeability assumption is essential to efficient algorithms for automatically eliciting the broad semantic themes in a collection of language token.

Another example of a modeling algorithm is the probabilistic latent semantic analysis (PLSA) model. PLSA is a statistical technique for analyzing two-mode and co-occurrence data. PLSA was evolved from latent semantic analysis, and added a sounder probabilistic model. PLSA has applications in information retrieval and filtering, natural language processing, machine learning from text, and related areas.

Once the semantic structures for the information resources are created, the recommendation application 107c matches each of them against the topology, to determine a suggested list of information resources that are relevant to the determined context of the user. In one embodiment, a match between a language token within the semantic structure and a language token included in the topology causes the token value of the token in the topology to be added to the token values of an identical token in the semantic structure. As such, the recommendation application 107c adjusts semantic structures of a plurality of information resources based upon the weighted topology (Step 403), by changing the token values therein.

Thereafter, the recommendation application 107c suggests one or more of the information resources to the user based, at least in part, on the adjusted semantic structures (Step 405). The suggested information resources are presented to the user via the UE 101. In addition, the recommendation application 107c updates the list based on changes in contextual information, at a predetermined time interval, or a combination thereof.

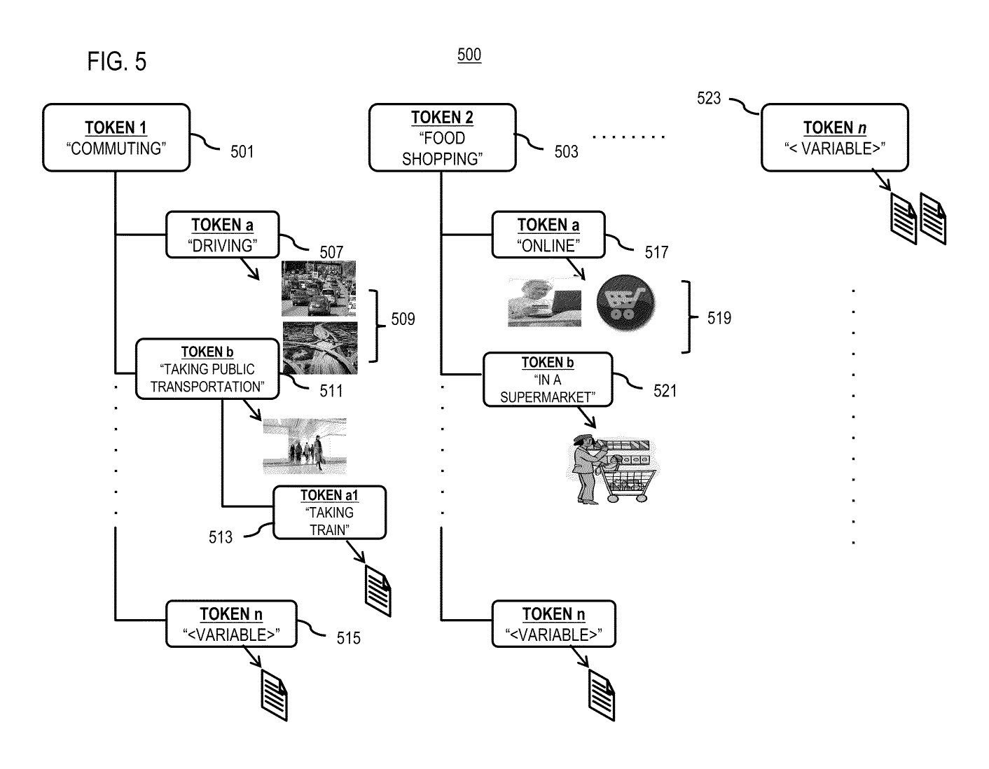

FIG. 5 illustrates a graphical representation of a group behavior structure comprising a plurality of language tokens, according to one embodiment. The system 100 takes into account the importance of community, cultural and country specific differences while also providing for a common platform that can be implemented globally. To achieve these goals, the recommendation application 107c generates token weightage in a dynamic manner via a rule-based behavior modeling framework as discussed in conjunction with FIG. 4 while maintaining the recommendation platform 201 generic. The group behavior structure 500 is extracted from the universal topology by applying one or more rules to select a weight value for each of the tokens of the topology based upon a community, culture, country, or combination thereof the user belongs to. As mentioned, the rules are set based upon community/culture/country studies and behavior studies.

The group behavior structure 500 is implemented as a data file, organized in accordance with a data structure so as to be readily interpreted, analyzed, reconstructed or deconstructed. Within this data file are one or more representative topics of group behaviors, wherein each topic is a composite token. As such, the set of tokens comprising the group behavior structure define a fixed, but expandable, set of potential group behavior topics. For the sake of clarity, the term “token” and “topic” will be recognized as synonymous terms, as the computational or semantic processing of the topology data file ultimately results in abstraction of the topics into one or more tokens.

Generally, a token can be a keyword, an operator, punctuation mark or any combination of words and/or characters comprising an input string or input document. In the context of the present example, each top level topic 501, 503 through 523 represent a pre-defined number of noun tokens—i.e., 1500 top level tokens. Hence, each descriptor variable of a given token is semantically recognized as a noun/behavior, i.e., “commuting,” “food-shopping,” etc. Each topic is further divided into one or more subclasses for further organization into subtopics. The predetermined group behavior structure 500 is thus hierarchically arranged, such that a defined/controlled number of top level topical tokens 501, 503 and 523 (e.g., topics) have respective subcategories 507, 511, 513, 515, 517 and 521 (e.g., subtopics). Subclasses of a given topic 501, 503 and 523 within the hierarchy can go down multiple depths and levels (further subclasses), representing, for instance, anywhere between 30 to 50 tokens depending on the nature of the top-level category.

With this in mind, it is not uncommon for the group behavior structure 500 of topics and subtopics of group behavior to represent a super-set of at least 7500 tokens or topics. Typically, the group behavior would belong to one or more (say 5) of the top classes (e.g., topics, categories) and then several of the sub-classes under each class that the system 100 has chosen. The categorization of group behaviors per community/culture/country can be manually performed by researchers and/or computers by extracting the information from different sources of information, such as social research papers and studies, surveys, censuses, public records, etc. with required granularity and precision. Furthermore, the hypothetically presented number of 7500 tokens is by way of example, not limitation. The number of tokens will grow as the granularity of topics rise and as new genres get identified or refined over time. Therefore, means for automation of this process following manual seeding of, for instance, one or more top level topics as provided herein.

With reference again to FIG. 5, each token within the group behavior structure 500 is also associated with a corresponding set of reference tokens. The set of reference tokens represents one or more tokens abstracted from a reference information source (e.g., a research paper, a shopping website, a supermarket survey, etc) assigned to each topic and subtopic of the universal topology. Each of the reference information sources is a resource that is determined to closely match the subject matter represented by the corresponding topic. As such, a reference information source provides a means of enabling group behavior correlation between the topical token and its actual semantic use. So, for example, Token 507 for the behavior “DRIVING (commuting to work),” has two associated live webcams/databases 509, which pertain to the subject matter of Washington D.C. downtown traffic lights/jams and the subject matter of highway traffic jams on the Capital Beltway. Token 511 for the behavior “TAKING PUBLIC TRANSPORTATION (to work),” has one sub-Token 513 for behavior “TAKING TRAIN (to work).”

As another example, Token 517 for behavior “ONLINE (food shopping),” has two associated websites 519, which pertain to the subject matter of organic food and the subject matter of supermarket chains. By way of example, the documents 519 may be specified from one or more online document repositories (e.g., the Agriculture Association or any other source) providing topic-related documents. Token 503 for the behavior “FOOD SHOPPING,” has another sub-Token 521 for behavior “in a supermarket (food shopping)”.

In one embodiment, the recommendation application 107c extracts a set of reference tokens from each reference information source to establish rules serving as a basis for applying taken values upon the universal topology per community/culture/country. In another embodiment, the recommendation application 107c generates the group behavior structure 500 on demand corresponding to a current context structure of the user.

In combination, the representative tokens abstracted from each individual group behavior reference information source act as a language model, providing specific information that can be used for deriving contextually accurate and relevant tokens representative of the group behaviors per community/culture/country. While the illustration depicts various group behavior information sources in association with a given token, indeed, this implicates a mapping of complimentary reference tokens as well.

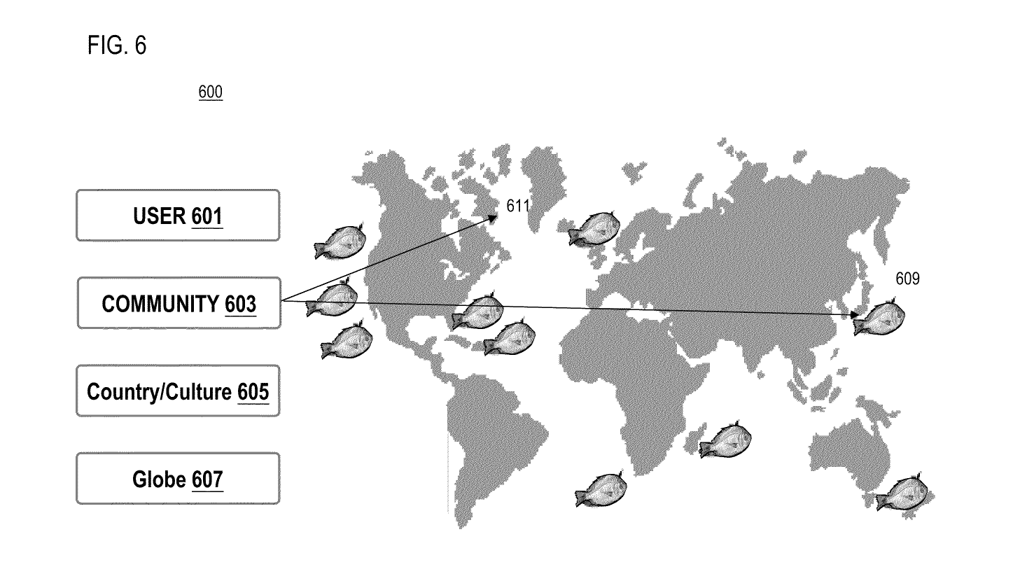

FIG. 6 is a diagram 600 showing major fishing communities around the world, according to one embodiment. For example, through interviews with community residents/users 601, the recommendation application 107c explores the connections between fishing communities 603, fisheries, the marine environment, and the fishing culture 605 around the globe 607. The group behavior structure 500 and the rules capture the culture, life styles, experiences of fishing community men and women 601 who take part in commercial and recreational fishing and other marine-related occupations in these towns and cities. For example, the northern territory of Hokkaido, Japan and its surrounding islands was the living environment of the Ainu people and their community 609. Their culture co-exists with a harsh natural environment, and hunting, fishing, gathering and farming was their source of livelihood. As fish catches diminished in coastal waters, Japanese fishing industry send factory ships to North Pacific Ocean and the Southern Ocean near Antarctica for fishing.

Fishing is also carried out in small numbers by various Inuit groups around a group of indigenous communities inhabiting the Arctic regions 611 of Canada, Denmark, Russia and the United States. Harvested meat is sold through shops and supermarkets in northern communities where fish meat is a component of the traditional diet. Each fishing community has its own group behavior patterns which can be converted into different weight values to reflect the community influences on the users of the community.

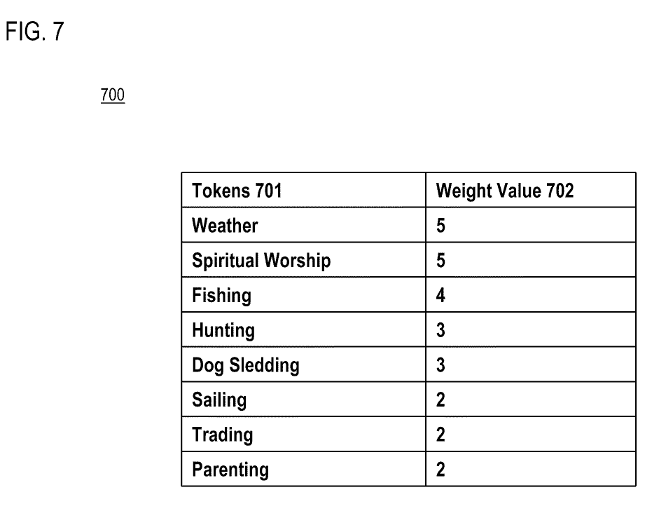

FIG. 7 shows an example 700 of weight values 702 among group behavior tokens 701 in a fishing community, according to one embodiment. This example is assembled for an Inuit fishing community. For example, Weather (5), Spiritual Worship (5), Fishing (4), Hunting (3), and Dog Sledding (3) are the top five group behaviors in the community. The weight values enable the recommendation application 107c to adjust the semantic structures of information resources based on the topology or a context structure (e.g., time, date, location, etc. of the behaviors) by incorporating community/culture/country weight differences.

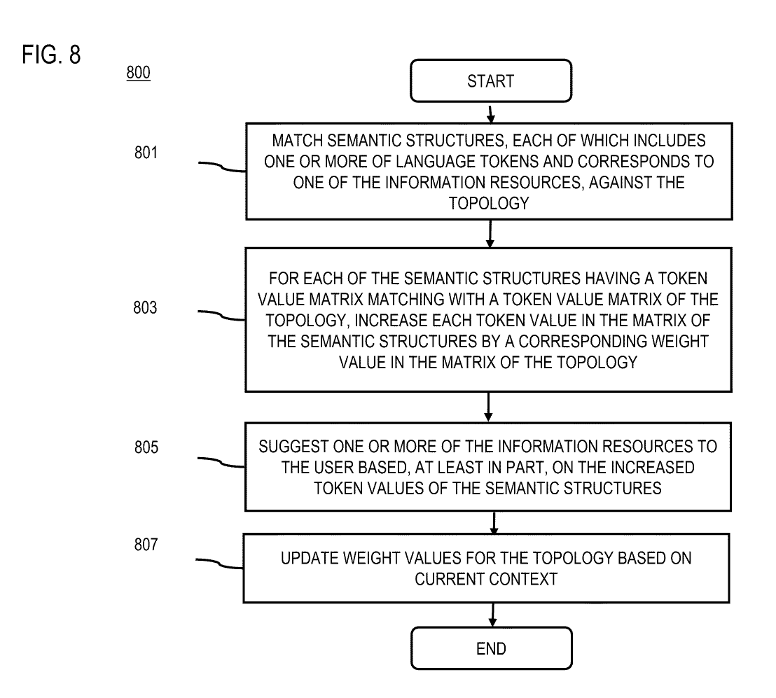

FIG. 8 is a flowchart of a process for adjusting the semantic structures of information resources based on a topology, according to one embodiment. In one embodiment, the recommendation application 107c performs the process 800 of FIG. 8 and is implemented in, for instance, a chip set including a processor and a memory as shown in FIG. 12. In Step 801, the recommendation application 107c matches semantic structures, each of which includes one or more of language tokens and corresponds to one of the information resources, against the topology. A token value matrix is a rectangular array of token values, such as

$$[ \begin{matrix}1 & 9 & 13 \\ 20 & 55 & 4\end{matrix} ] .$$

This matrix has entries 1, 9, 13, 20, 55, and 4. Matrices of the same size can be added and subtracted entry wise. For each of the semantic structures having a token value matrix matching with a token value matrix of the context structure, the recommendation application 107c increases each token value in the matrix of the semantic structures by a corresponding weight value in the matrix of the topology (Step 803). The recommendation application 107c suggests the information resources to the user based, at least in part, on the increased token values of the semantic structures (Step 805). In one embodiment, each of the suggested information resources has an aggregate matrix value satisfying a threshold. In another embodiment, a predetermined number of the information resources with an aggregate matrix value higher than other information resources are suggested to the user. Thereafter, the recommendation application 107c updates/calculates weight values for the topology based on current context (Step 807). By way of example, the community behaviors at noon (e.g., taking business lunches, running personal errands, etc.) are different from the behaviors in the morning (e.g., sending children to school, commuting to work, etc.) such that the applicable rules are different. Thus, the weight values are changed accordingly.

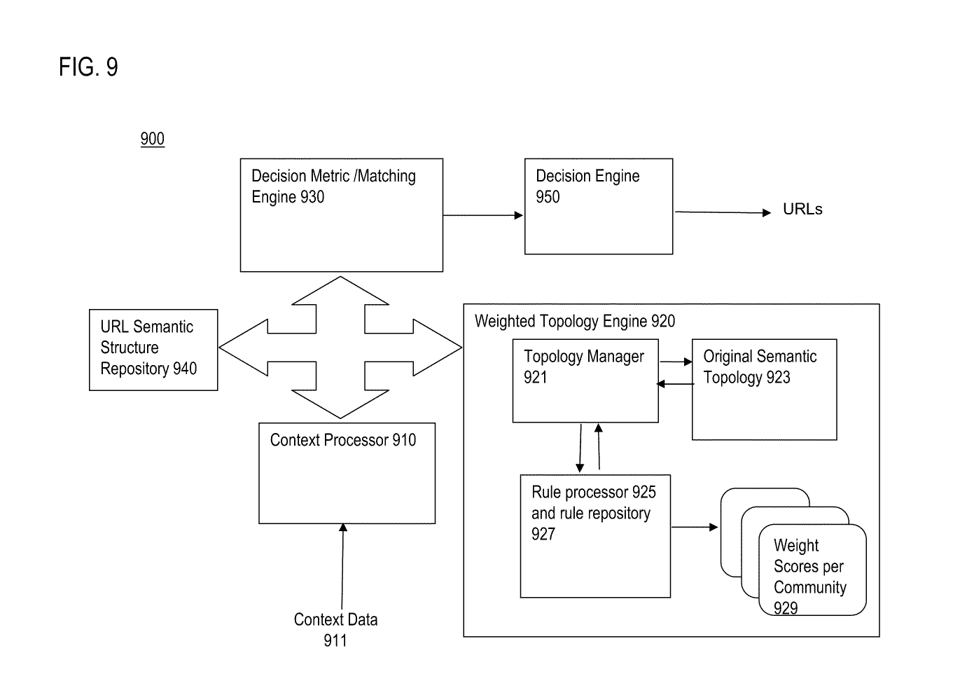

FIG. 9 is a diagram of the components of a recommendation engine, according to one embodiment. By way of example, the recommendation engine 900 includes one or more components for suggesting information resources based on contextual, preferential and group behavior information. It is contemplated that the functions of these components may be combined in one or more components or performed by other components of equivalent functionality. In this embodiment, the recommendation engine 900 combines a preference structure and a context structure (e.g., received externally from the UE 101a) to build a combined data structure for a user. By way of example, a user preference and/or context engines on the UEs 101a, 101b (not shown) monitor what activities the users are engaged in and/or where the user presences are (a location, cell numbers, GPS coordinates, etc.), and perform advanced data mining for individual preference and context. The recommendation engine 900 then uses this combined structure to derive/compute match metrics against each semantic structure derived from each information resource (e.g., web sites). The websites that have the most or more match metrics are chosen and pushed to the UE 101a.

In another embodiment, the recommendation engine 900 adds a layer in-between the preference structure and the context structure to build a better match metric reflecting importance of certain tokens of a particular community/culture/country.

Based upon the rule-based group behavior modeling framework, the system 100 makes the universal topology of tokens into a weighted topology that is taken into account by the recommendation engine of the system 100 when constructing the metric. The framework involves a context processor 910, a weighted topology engine (WTE) 920, and a matching engine 930 interacting with one another as follows.

The context processor 910 imports from the UE 101a and processes context data 911 into a context structure. The context data structure is transmitted to both the matching engine 930 and the WTE 920. The WTE 920 includes a topology manager (TM) 921, an original semantic topology (ST) 923, a rule processor (RP) 925, a rule repository 927, and weight scores/values (WS) 929 per community/culture/country. The weight scores 929 are different for each type of community and for each type of culture/country, and the weight scores 929 reflect the particular weight value for each topic that is given importance by the community/culture/country for which that weight scores depict. The weight scores 929 are determined through user studies and behavioral studies. In this manner, the recommendation engine 900 can vary weight scores 929 corresponding to behaviors of different communities/cultures/countries while keeping most of rules static. In another embodiment, the recommendation engine 900 can change the rules.

The rule processor 925 contains rule sets that determine which weight scores 929 to take per community/culture/country, based on differing context (e.g., fishing, shopping, commuting, etc.). The rules are either constructed dynamically based on state languages or statically defined to be applied to specific sets of context. If one or two context keys have a value that fall between certain boundaries, then a specific rule is chosen. Each rule then selects an appropriate weight score per community/culture/country. The recommendation engine 900 computes a weight value for each token within the semantic topology 923 for a particular community/culture/country. The weight value for each token within the topology is determined by the context data, its token values with the context structure, and the weight scores 929. These values are used in accordance with the rules, and the weighted topology is computed. The topology 923 is not affected by only weights associated with each token within the topology. Once the weighted topology is completed, it is passed to the matching engine 930.

The matching engine 930 also receives from a URL semantic structure repository 940 a plurality of semantic structures extracted from each information resource (e.g., URL). The matching engine 930 matches the context data structure against the semantic structures, and sends the matched results to an decision engine 950 to find a specific set of URLs that are highly relevant to the user's preference, context, and group behavior of the community/culture/country that the user belongs to.

In one embodiment, the matching engine 930 parses the weighted topology and stores all weight values and associated tokens that have values above a threshold (e.g., 1). When computing the matrix score (per URL), all URL semantic structures containing those tokens that have value above a threshold (e.g., 1) in the weighted topology are adjusted by adding thereon those weight values of a matching metric of the context data structure. Therefore, those tokens in the URL semantic structures having high token values get even higher values against others not containing the tokens of the context structure, after adding the weight values for the particular community/culture/country. Those tokens in the URL structures having high token values still would have given a higher score were the weight values not applied in the first place. This means that group behavior aspects given weightage are reflected in the final match taken values, such that the context and behavioral patterns get reflected in the URL list so determined.

By way of example, the recommendation engine 900 recommends a 30-min video clip of news to a person taking a morning taxi ride in Beijing, while recommending a simple RSS feed of international news to the same person if in Helsinki This is based on estimated time for commuting in the two communities. This results in reusing almost all functions of the recommendation engine (including the rule sets) everywhere, but different metrics for different tokens within the original topology that results in different matches even if all the context aspects are same. Thus, the recommendation engine 900 provides a highly adaptive backend and a scalable and efficient information resource recommendation service.

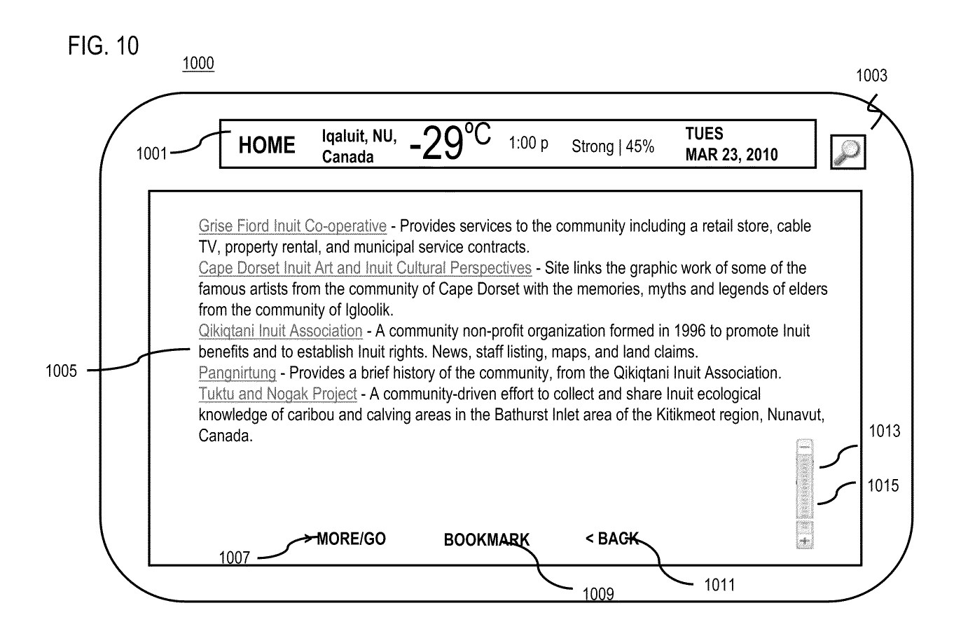

FIG. 10 is diagram of a user interface 1000 presenting information resources, according to one embodiment. The user interface may be a LCD screen, such as a touch screen, etc. In this embodiment, the system 100 automatically updates the context of user, and continuously updates the list of information resources. A top bar 1001 indicates a current location (Iqaluit, NU, Canada), temperature (−29° C.), time (1:00 pm), wind (strong), humidity (45%), and date (Tuesday, Mar. 23. 2010). The list of information resources is always ready to be called up by the user. The user may select (by touching, clicking, etc.) an icon 1003 to display a list of information resources 1005 recommended by the system 100. In this case, the user does not have to take any action other than selecting the button 1003 to get a personalized recommendation list. This feature makes it easy for new users of a mobile terminal, such as people in the developing countries with very limited information device knowledge or experience, to get the recommendations.

In one embodiment, each of the information resources is listed with a short description of the resources. For example, the Grise Fiord Inuit Co-operative provides services to the community including a retail store, cable TV, property rental, and municipal service contracts. Optionally, the URL of the information resource can be listed. In another embodiment, one or more of the listed information resources are provided in thumbnails. By selecting a desired information resource, it is highlighted and/or enlarged, such that the user may select a “MORE/GO” icon/button 1007 to display more detailed description of the information resource or to browse the corresponding URL. The user can bookmark an information resource by selecting “BOOKMARK” 1009. The user can move back to the prior screen by selecting “BACK” 1011.

The user's selection or other feedback is monitors by the recommendation application 107a of the UE 101 as implicit relevance feedback with respect to the selected information resources. In another embodiment, the user can explicitly indicate the user's interest with respect to the information resource by moving up and down of an interest lever 1015 in a user interest bar 1013. When the user selects the information resource in the list and/or rates high of the information resource, the information resource likely matches the user's preference, context, and/or group behaviors. The system 100 increases relevant token values of the selected information resource and feed them back to adjust the store taken values and/or rules. On the other hand, if the user does not select some of the information resources in the list and/or rates low of the information resources, the information resource does not match the user's preference, context, and/or group behaviors. The system 100 decreases relevant token values of the selected information resource and feed them back to adjust the store taken values and/or rules. Therefore, the system 100 refines/trains itself to provide a better recommendation list meeting the user's need and interest.

The processes described herein for providing personalized information resource recommendation based on group behaviors suggesting information resources based on context and preferences may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

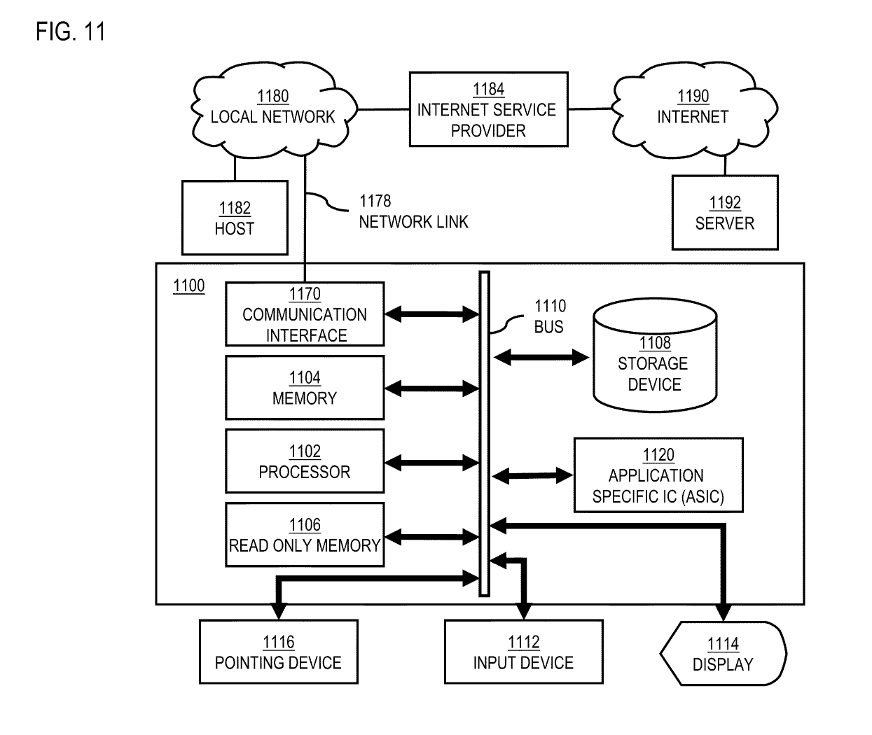

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to provide personalized information resource recommendation based on group behaviors as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of providing personalized information resource recommendation based on group behaviors.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to provide personalized information resource recommendation based on group behaviors. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for providing personalized information resource recommendation based on group behaviors. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing personalized information resource recommendation based on group behaviors, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for providing personalized information resource recommendation based on group behaviors.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to provide personalized information resource recommendation based on group behaviors as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of services. Chip set or chip 1200, or a portion thereof, constitutes a means for performing one or more steps of providing personalized information resource recommendation based on group behaviors.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide personalized information resource recommendation based on group behaviors. The memory 1205 also stores the data associated with or generated by the execution of the inventive steps.

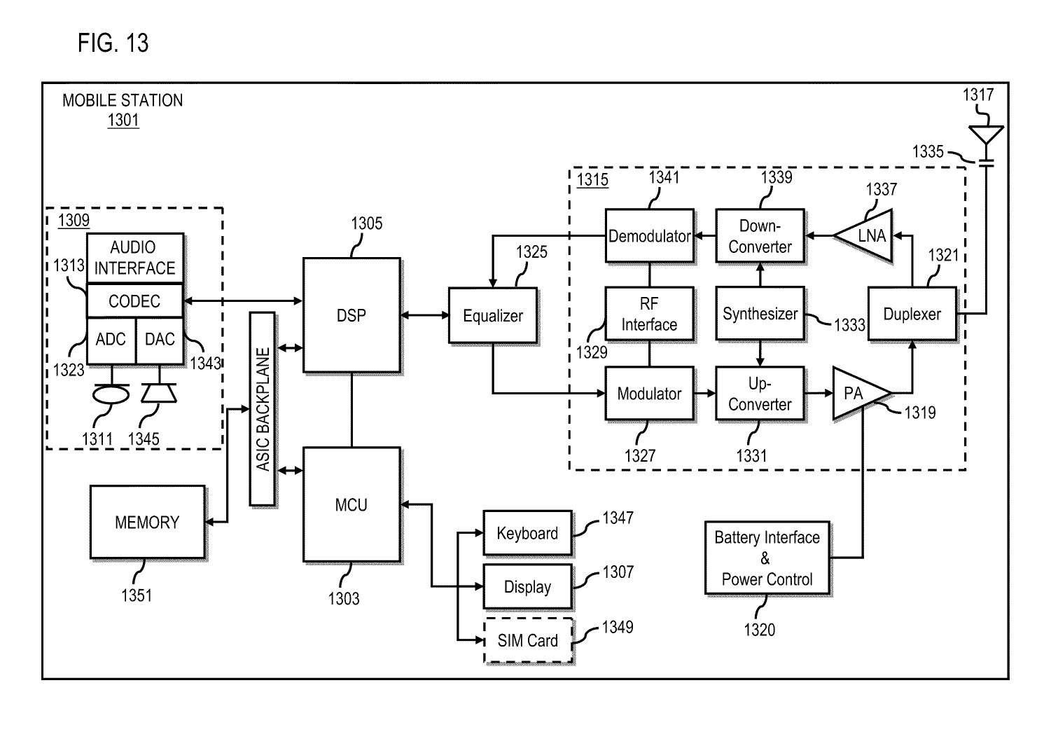

FIG. 13 is a diagram of exemplary components of a mobile terminal (e.g., handset) for communications, which is capable of operating in the system of FIG. 1, according to one embodiment. In some embodiments, mobile terminal 1300, or a portion thereof, constitutes a means for performing one or more steps of providing personalized information resource recommendation based on group behaviors. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of providing personalized information resource recommendation based on group behaviors. The display 13 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to provide personalized information resource recommendation based on group behaviors. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
applying one or more rules to select a weight value for tokens within a language topology based upon group behaviors of a community, culture, country, or combination thereof that a user belongs to;
adjusting semantic structures of a plurality of information resources based upon the weighted topology; and
suggesting one or more of the information resources to the user based, at least in part, on the adjusted semantic structures.

2. A method of claim 1, wherein the topology is extracted from a universal dictionary, and the tokens within the language topology are mapped to a context structure that is received from a user terminal and reflects current context of the user.

3. A method of claim 1, wherein the semantic structures are adjusted by:
matching the semantic structures, each of which includes one or more of language tokens and corresponds to one of the information resources, against the topology; and
for each of the semantic structures having a token value matrix matching with a token value matrix of the topology, increasing each token value in the matrix of the semantic structures by a corresponding weight value in the matrix of the topology,
wherein the information resources suggested to the user are determined based, at least in part, on the increased token values of the semantic structures.

4. A method of claim 1, further comprising pre-defining the rules for a plurality of sets of context, constructing the rules based upon state languages on demand, or a combination thereof.

5. A method of claim 2, wherein the context structure includes tokens that reflect user characteristics, interests, preferences, or a combination thereof of the user.

6. A method of claim 1, wherein the topology includes words of all languages.

7. A method of claim 1, wherein each of the suggested information resources have an aggregate matrix value satisfying a threshold, or a predetermined number of the information resources with an aggregate matrix value higher than other information resources are suggested to the user, or a combination thereof

8. An apparatus comprising:
at least one processor; and
at least one memory including computer program code,
the at least one memory and the computer program code configured to, with the at least one processor, cause the apparatus to perform at least the following,
apply one or more rules to select a weight value for tokens within a language topology based upon group behaviors of a community, culture, country, or combination thereof that a user belongs to;
adjust semantic structures of a plurality of information resources based upon the weighted topology; and
suggest one or more of the information resources to the user based, at least in part, on the adjusted semantic structures.

9. An apparatus of claim 8, wherein the topology is extracted from a universal dictionary, and the tokens within the language topology are mapped to a context structure that is received from a user terminal and reflects current context of the user.

10. An apparatus of claim 8, wherein the apparatus adjusts the semantic structures by:
matching the semantic structures, each of which includes one or more of language tokens and corresponds to one of the information resources, against the topology; and
for each of the semantic structures having a token value matrix matching with a token value matrix of the topology, increasing each token value in the matrix of the semantic structures by a corresponding weight value in the matrix of the topology,
wherein the information resources suggested to the user are determined based, at least in part, on the increased token values of the semantic structures.

11. An apparatus of claim 8, wherein the apparatus is further caused to: pre-define the rules for a plurality of sets of context, construct the rules based upon state languages on demand, or a combination thereof.

12. An apparatus of claim 9, wherein the context structure includes tokens that reflect user characteristics, interests, preferences, or a combination thereof of the user.

13. An apparatus of claim 8, wherein the topology includes words of all languages.

14. An apparatus of claim 8, wherein each of the suggested information resources have an aggregate matrix value satisfying a threshold, or a predetermined number of the information resources with an aggregate matrix value higher than other information resources are suggested to the user, or a combination thereof.

15. A computer-readable storage medium carrying one or more sequences of one or more instructions which, when executed by one or more processors, cause an apparatus to at least perform the following steps:
applying one or more rules to select a weight value for tokens within a language topology based upon group behaviors of a community, culture, country, or combination thereof that a user belongs to;
adjusting semantic structures of a plurality of information resources based upon the weighted topology; and
suggesting one or more of the information resources to the user based, at least in part, on the adjusted semantic structures.

16. A computer-readable storage medium of claim 15, wherein the topology is extracted from a universal dictionary, and the tokens within the language topology are mapped to a context structure that is received from a user terminal and reflects current context of the user.

17. A computer-readable storage medium of claim 15, wherein the apparatus adjusts the semantic structures by:
matching the semantic structures, each of which includes one or more of language tokens and corresponds to one of the information resources, against the topology; and
for each of the semantic structures having a token value matrix matching with a token value matrix of the topology, increasing each token value in the matrix of the semantic structures by a corresponding weight value in the matrix of the topology,
wherein the information resources suggested to the user are determined based, at least in part, on the increased token values of the semantic structures.

18. A computer-readable storage medium of claim 15, wherein the apparatus is caused to further perform: pre-defining the rules for a plurality of sets of context, constructing the rules based upon state languages on demand, or a combination thereof.

19. A computer-readable storage medium of claim 16, wherein the context structure includes tokens that reflect user characteristics, interests, preferences, or a combination thereof of the user.

20. A computer-readable storage medium of claim 15, wherein the topology includes words of all languages.

21.-55. (canceled)
